(19) United States
(12) Patent Application Publication
(10) Pub. No.: US 2005/0060053 A1
(43) Pub. Date: Mar. 17, 2005

(54) Method and apparatus to adaptively insert additional information into an audio signal, a method and apparatus to reproduce additional information inserted into audio data, and a recording medium to store programs to execute the methods

(76) Inventor: Arora Manish, Suwon-si (KR)

Correspondence Address: STANZIONE & KIM, LLP, 1740 N STREET, N.W., FIRST FLOOR, WASHINGTON, DC, 20036, US

(21) Appl. No.: 10/919,512

(22) Filed: Aug. 17, 2004

(30) Foreign Application Priority Data
Sep. 17, 2003 (KR) 2003-64583

(51) Int. Cl. G06F 17/00

(52) U.S. Cl. 700/94

(57) ABSTRACT

A method of and apparatus to adaptively insert additional information into input audio data, a method of and apparatus to replay karaoke information from audio data, and a recording medium having recorded thereon programs to execute the methods. The method of adaptively inserting additional information into input audio data includes calculating an energy value of the input audio data in audio block units that have a predetermined size, determining an insertion pattern used based on the calculated energy value of a current audio block to insert the additional information, and inserting additional information based on the determined insertion pattern in sub-audio block units of the current audio block.

### CROSS-REFERENCE TO RELATED APPLICATIONS

This application claims the priority of Korean Patent Application No. 2003-64583, filed on Sep. 17, 2003, in the Korean Intellectual Property Office, the disclosure of which is incorporated herein in its entirety and by reference.

### BACKGROUND OF THE INVENTION

1. Field of the Invention

The present general inventive concept relates to a method and apparatus to adaptively insert additional information into an audio signal, a method and apparatus to replay additional information inserted into audio data, and a recording medium to store programs to execute the methods.

2. Description of the Related Art

A pulse code modulation (PCM) method samples analog data for predetermined cycles, quantifies and binary encodes the analog data into 8, 16, 32, or 64 bits.

A bit robbing method used in the present general inventive concept is a method of using predetermined bits in the PCM sample to add information unrelated to original information, which the original PCM sample contains, to the PCM sample. The predetermined bits are used regularly among the PCM sampled data, for example, to transmit predetermined contents and to form an independent channel in the PCM data.

Such a bit robbing method is used in a T-carrier system, which is widely used to transmit voices and data through a public switched telephone network (PSTN) and personal networks. In such a system, information on which bits will be used among PCM samples should be notified beforehand. This method is disclosed in U.S. Pat. No. 5,864,600.

Therefore, since data rate of the inserted information is limited, it is hard to insert sufficient additional information needed to apply in various applications in the bit robbing method used in the communication system in the prior art. Furthermore, when increasing additional information, noise occurs in an audio signal.

### SUMMARY OF THE INVENTION

The present general inventive concept provides a method and apparatus to adaptively insert additional information according to the energy level of input audio data without deterioration of audio sound quality.

The present invention also provides a method and apparatus to reproduce additional information from the audio data in which the additional information is inserted.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a method of adaptively inserting additional information into input audio data, the method including computing an energy value of the input audio data in audio block units which have a predetermined size, determining an insertion pattern used to insert the additional information based on the computed energy value of a current audio block, and inserting additional information in sub-audio block units of the current audio block based on the determined insertion pattern.

The foregoing and/or other aspects and advantages of the present general inventive concept are also achieved by providing an apparatus to adaptively insert additional information into input audio data, the apparatus including an energy level determination unit which computes an energy value of the input audio data in audio block units having a predetermined size and determines an insertion pattern used to insert the additional information based on the computed energy value of a current audio block, and an additional information insertion unit which inserts the additional information in sub-audio block units of the current audio block based on the determined insertion pattern.

The foregoing and/or other aspects and advantages of the present general inventive concept are also achieved by providing a method of reproducing additional information inserted into input audio data, the method including computing an energy value of the input audio data in audio block units of a predetermined size, determining an insertion pattern used to insert the additional information based on the computed energy value of a current audio block, and extracting the additional information inserted into the current audio block in sub-audio block units based on the determined insertion pattern.

The foregoing and/or other aspects and advantages of the present general inventive concept are also achieved by providing an apparatus to replay additional information inserted into input audio data, the apparatus including an energy level computing unit which computes an energy value of the input audio data in audio block units of a predetermined size, and an additional information extracting unit which determines an insertion pattern used to insert the additional information based on the computer energy value and extracts the additional information inserted in sub-audio block units of the current audio block based on the determined insertion pattern.

The foregoing and/or other aspects and advantages of the present general inventive concept are also achieved by providing a method of reproducing additional information inserted into input audio data, the method including detecting synchronization information from the input audio data, extracting duration information and bit robbing pattern information in sub-audio block units when a start synchronization word of the detected synchronization information is valid, and extracting the additional information from the sub-audio blocks based on the extracted duration information and bit robbing pattern information, wherein the duration information indicates a range of the sub-audio block in which the additional information is inserted, and the bit robbing pattern information includes information on a number of bits used to insert additional information in the sub-audio blocks.

The foregoing and/or other aspects and advantages of the present general inventive concept are achieved by providing an apparatus to reproduce additional information inserted into input audio data, the apparatus including a synchronization detecting unit which detects synchronization information from the input audio data, a duration and bit robbing pattern information extracting unit which extracts duration information and bit robbing pattern information in sub-audio block units when a start synchronization word of the detected synchronization information is valid, and an additional information extracting unit extracting additional information from the sub-audio blocks based on the extracted duration information and bit robbing pattern information, wherein the duration information indicates a range of the sub-audio block in which the additional information is inserted and the bit robbing pattern information includes information on a number of bits used to insert information in the sub-audio blocks.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 illustrates a method of perceptual encoding according to an embodiment of the present general inventive concept;

FIGS. 2A and 2B illustrate a method of inserting additional information into an audio signal used in the present general inventive concept;

FIG. 3 is a block diagram illustrating a device to adaptively insert additional information into an audio signal according to an embodiment of the present general inventive concept;

FIG. 4 illustrates an example of structure of a lyrics data packet used in the embodiments of the present general inventive concept;

FIG. 5 illustrates structure of an MIDI data packet used according to an embodiment of the present general inventive concept;

FIG. 6 illustrates a scrambler used according to an embodiment of the present general inventive concept;

FIG. 7 is a flow chart illustrating a method of adaptively inserting additional information in an audio signal according to an embodiment of the present general inventive concept;

FIG. 8 is a block diagram illustrating a device to replay additional information in an audio signal according to an embodiment of the present general inventive concept;

FIG. 9 illustrates a descrambler according to an embodiment of the present general inventive concept;

FIG. 10 is a flow chart illustrating a method of replaying additional information in an audio signal according to an embodiment of the present general inventive concept;

FIG. 11 is a block diagram illustrating a device to replay additional information according to another embodiment of the present general inventive concept; and

FIG. 12 is a flow chart illustrating a method of replaying additional information in an audio signal according to still another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

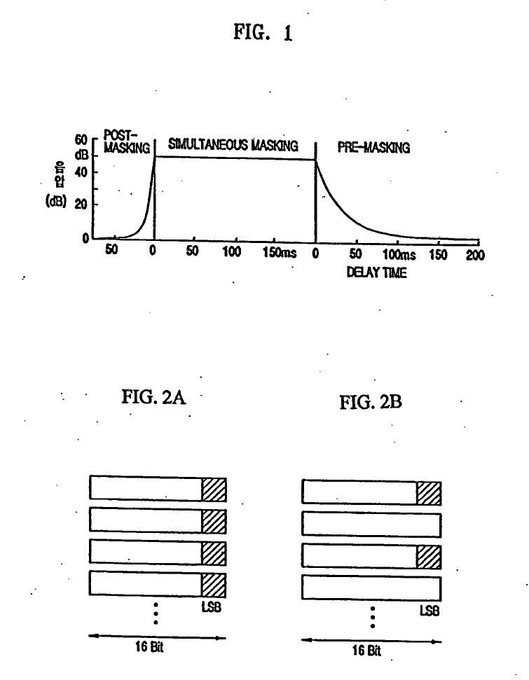

FIG. 1 is a drawing illustrating a bit-robbing method used according to an embodiment of the present general inventive concept.

A bit-robbing method is used to insert additional information, for example, lyrics, MIDI data, etc., into a PCM sample of audio data.

The position and number of bits that are bit-robbed are determined by taking into account psychoacoustic characteristics.

For example, in PCM encoded audio signals, when an energy level of an audio signal is higher than a predetermined value, even when inserting additional information into a plurality of least significant bits (LSB) of audio samples, the noise created is not audible because of the original audio signal. Therefore, it is possible to insert additional information used in various applications according to the energy level of the audio signal by adaptively inserting additional information, without affecting sound quality.

FIG. 1 illustrates a perceptual encoding method used in an embodiment of the present general inventive concept.

FIG. 1 illustrates simultaneous-masking, in which masking occurs due to a masking sound, and pre-masking and post-masking which mask the sounds from the front and back. As shown in FIG. 1, a masking effect, that is, a pre-masking and post-making effect occurs, which is referred to as a temporal masking effect.

In simultaneous-masking, the masking effect is shown proportional to the sound pressure of the masking sound. Furthermore, the shorter the time difference with the masking sound, the greater the temporal masking effect.

In the present general inventive concept, the masking effect is used to insert more information into an audio signal within the range in which a listener can not perceive deterioration in sound quality.

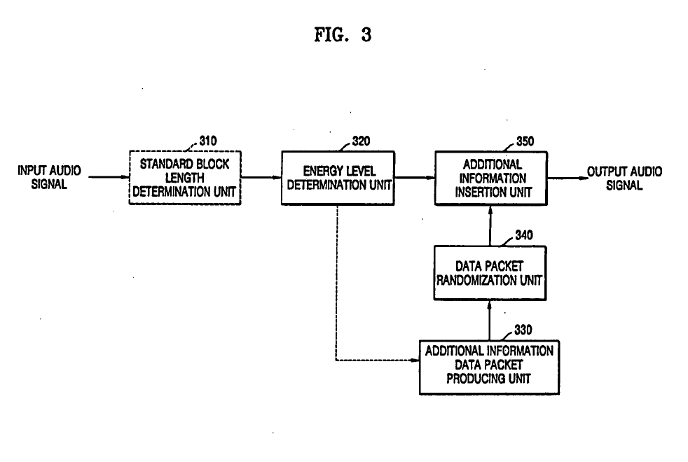

Exemplary embodiments of the present general inventive concept will be described below while referring to FIGS. 2A through 12.

FIGS. 2A and 2B are drawings illustrating a bit-robbing method used according to an embodiment of the present general inventive concept.

FIG. 3 is a block diagram illustrating an encoder to insert additional information into an input audio signal according to an embodiment of the present general inventive concept.

The encoder according to FIG. 3 includes a standard block length determination unit 310, an energy level determination unit 320, an additional information data packet producing unit 330, a data packet randomisation unit 340, and an additional information insertion unit 350.

The standard block length determination unit 310 determines a length of a standard block to compute an energy level according to the input audio signal characteristics. For example, when the input audio signal is a music signal, the data unit to calculate an energy level is 30-50 msec, and when the input audio signal is a speech signal, the data unit is 20 msec, which is the result when taking into account the fact that the range of energy change according to time is larger for speech signals than music signals.

According to the present embodiment, the length of an audio block is determined using the standard block length determination unit 310. However, using audio blocks with optionally selected lengths is possible.

The energy level determination unit 320 calculates the energy of the input audio signal in standard block units, which have a determined length in the standard block length determination unit 310. An audio signal with a determined length is referred to as an audio block. For example, when the input audio signal is a music signal, the length of an audio block, which is a calculating unit of energy blocks, is 30-50 msec.

The calculated energy is compared with a predetermined threshold value and the energy level of the input audio signal is determined. In the present embodiment, the energy level of the audio signal of predetermined data units is categorized into low, intermediate, or high level energy.

The energy level determined in the energy level determination unit 320 is used to adaptively insert additional information into not only the current audio block but also previous and post audio blocks with respect to the current audio block. Inserting additional information into sub-audio blocks is carried out, for example, in PCM sample units. The case in which the number of bits of a PCM sample is 16 will be described below for convenience.

The number of bits and positions used to insert additional information into a PCM sample is determined according to the energy level of audio blocks.

For example, when the energy level of the current audio block is less than a first reference value, that is, when the energy level is low, since the signal level cannot mask noise created by inserting addition information into a PCM sample, that is, bits of an audio block which are bit-robbed, additional information is not inserted into the PCM sample. In other words, when the noise created by inserting bits can be detected by a user, additional information is not inserted into the audio blocks of the audio signal.

However, as an option, the energy level determination unit 320 can insert additional information into audio data when the energy of previous or post audio blocks of a current audio block is greater than a first reference value. That is, when the energy level is intermediate or high, additional information can be inserted into audio data. This is because due to the pre-masking and post-masking as shown in FIG. 1, even when the energy level of the current audio block is low, when the energy level of the previous or post audio block is high, the noise created by inserting the additional information is not detected by the user.

In addition, when the energy level of the current audio block is greater than the first reference value and smaller than a second reference value, that is, when the energy level is intermediate, a predetermined number of bits among the 16-bit PCM sample data, for example, the least significant bit (LSB), is used to insert additional information. This is because the noise created by bit-robbed bits is masked due to the psychoacoustic effect, that is, the noise created by an inserted bit is not detected by a user. Therefore, when the energy level of the current audio block is intermediate, in the present embodiment, additional information is inserted into a predetermined number of the least significant bits of the PCM sample shown in FIG. 2A.

Furthermore, when the energy of the current audio block is greater than a second reference value, that is, when the energy level is high, for the same reason as in the intermediate level, additional information is inserted using the least significant bit and multiple bits adjacent to the least significant bit among the 16-bit PCM samples shown in FIG. 2A. This is because even when multiple bits, including the least significant bit, are bit-robbed in the high energy level, listeners do not perceive noise created by the bit-rob since the noise is masked by the psychoacoustic effect.

When the energy level of the current audio block is high, there are more bits that can be bit-robbed than when the energy level of the current audio block is intermediate.

In the present embodiment, when the energy level of the audio block is intermediate or high, as shown in FIG. 2A, the inserted additional information is inserted in each PCM sample of the relevant audio block. However, as an option, inserting additional information for a predetermined number of PCM sample intervals into relevant audio blocks is possible as shown in FIG. 2B.

Furthermore, in the present embodiment, when the energy level of the current audio block is low and the energy level of the previous or post audio block of the current audio block is intermediate or high, additional information can be inserted into each PCM sample of the relevant audio block (i.e., the previous or post audio block which is intermediate or high). However, as another option, it is possible to insert additional information at an interval of a predetermined number of PCM samples of the relevant audio block.

By taking into account the psychoacoustic effect of the PCM samples, it is possible to adaptively determine the bits and number of bits of the PCM samples that will be bit-robbed to be perceptually similar to the original PCM samples modified by the bit-robbing method.

In the present embodiment, when the energy level of the current audio block is intermediate or high, or even when the energy level of the current audio block is low and the energy level of the previous or post audio block (sub audio block) is high, when reducing the dynamic range of each PCM sample for a predetermined number of bits by bit-robbing the audio block that has a high energy level, the effect of bit-robbing is almost undetectable. This is because, in general, additional information data packets are transmitted within 5% to 10% of an audio data stream.

For example, when one bit is bit-robbed for 5% of the time and two bits are bit robbed for 3% of the time, bits that can be bit-robbed are 9702 bits per second, that is (5×1×44100×2+3×2×44100×2)/100. Therefore, within the range in which listeners cannot perceive the deterioration of audio sound quality, additional information of the bit rate is inserted into the audio signal and it is possible to realize various applications. Especially, by using a method of inserting additional information adaptively based on the psychoacoustic effect according to the present general inventive concept, it is possible to insert more additional information into the audio signal within the range in which listeners cannot perceive deterioration of sound quality.

The energy level determination unit 320 transmits insertion information including information related to the number of PCM samples used to insert additional information based on the determined energy level, to the additional information data packet producing unit 330.

As an option, the insertion information can include position information to be used in inserting additional information.

In the additional information data packet producing unit 330, additional information data packets are generated to be inserted into the audio data.

FIG. 4 illustrates the structure of an additional information data packet used in the previous embodiment of the present general inventive concept. The additional data packet according to FIG. 4 includes a synchronization word, duration information, and additional data.

The start synchronization word indicates the beginning of the additional information data packet. The start synchronization word uses 16 bits in the present embodiment. 16 bits is a sufficient length for a start code and the false detection rate is very low. In the present embodiment the start synchronization word is inserted using the least significant bit of the PCM sample without taking into account the energy level.

Duration information indicates the number of PCM samples used to insert additional information. In the present embodiment, the duration information uses 16 bits after the synchronization word and is inserted using the least significant bit of the PCM sample. The reason for including information on the number of PCM samples in which additional information is inserted in the duration information is so that bit-robbing of the PCM samples is not performed afterwards when predetermined additional information has already been inserted, even if the energy level is intermediate or high.

Additional data are adaptively inserted into PCM samples based on the energy level of the current audio block, the previous audio block, and the post audio block.

For example, when the energy level of the current audio block is intermediate, additional data is inserted using a least significant bit of the PCM sample. In addition, when the energy level of the current audio block is high, additional data is inserted using multiple bits of the PCM sample. Furthermore, when the energy level of the current audio block is low and the energy levels of the previous or post audio block are intermediate or high, additional data is inserted using the least significant data of the PCM sample.

In the present embodiment, according to the energy level of the current audio block, the previous audio block, and the post audio block, the number of bits that are bit-robbed are classified into one or multiple bits. However, the number of bits that are bit robbed according to energy level may have different patterns. For example, when the energy level of the current audio block is intermediate, it is possible to use more than one bit for each PCM sample to insert additional data, as shown in FIG. 2A. Furthermore, when the energy level of the current audio block is low and the energy level of the previous or post audio block is intermediate or high, it is possible to use a least significant bit for each predetermined number of PCM samples when inserting additional data, as shown in FIG. 2B.

The end synchronization word indicates that the additional data packets are all inserted. In the present embodiment, 16 bits are used for the length of the end synchronization word.

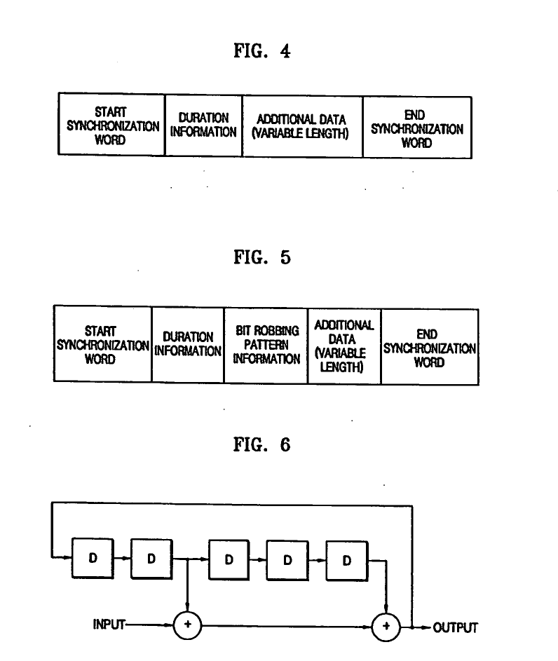

FIG. 5 shows the structure of an additional information data packet used in another embodiment of the present general inventive concept. The additional information data packet according to FIG. 5 includes a start synchronization word, duration information, bit robbing pattern information, and additional data. The start synchronization word and duration information perform similar functions as shown in FIG. 4, and therefore a detailed description thereof will not be provided.

The bit-robbing pattern information includes, for example, information on the number of bits used to insert additional data among PCM samples. As another option, the bit-robbing pattern information can be used to indicate the position information of a bit used to insert additional data. For example, additional data can be inserted for five PCM sample intervals.

The data packet randomisation unit 340 randomises additional information data packets generated in the additional information data packet producing unit 330 and outputs randomised data packets to the additional information insertion unit 350. In the present embodiment, by using the data packet randomisation unit 340, generated additional information data packets are randomised and output to the additional information insertion unit 350. However, as another option, it is possible to output the generated additional information data packets to the additional information insertion unit 350 without randomisation, thus bypassing the data packet randomisation unit 340. The randomised additional information data packets are inserted into the PCM sample functions as a dither signal to the most significant bit (MSB).

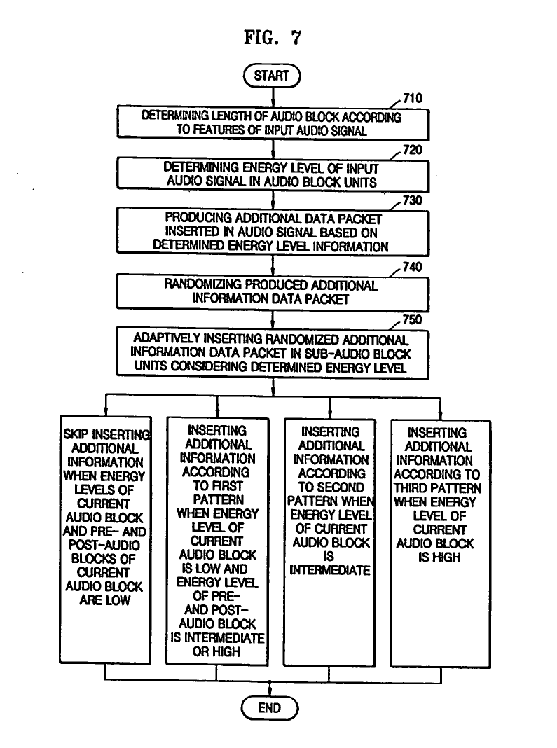

FIG. 6 illustrates an example of a scrambler that uses a feedback shift register, which is used to randomise data packets in the data packet randomisation unit 340.

The additional information insertion unit 350 inserts additional information, which is input from the data packet randomization unit 340 or the additional information data packet producing unit 330, into sub-audio blocks, for example, by PCM sample units in the energy level determination unit 320 according to the information on energy levels of the audio blocks. The synchronization word, duration information, and bit-robbed pattern information of the additional information data packet shown in FIG. 5 are inserted into a PCM sample using the least significant bit of the PCM sample, and additional data is adaptively inserted into the PCM samples according to the energy levels of audio blocks. For example, when the energy level of the current audio block is low, additional information insertion is skipped.

However, as another option, even if the energy level of the current audio block is low, when the energy level of the previous and post audio blocks are intermediate or high, it is possible to insert additional information according to a first pattern. The additional information insertion according to the first pattern is a method of inserting additional data using a predetermined number of sub-audio block intervals, for example, using least significant bits of PCM samples at an interval of five PCM samples.

In addition, when the energy level of the current audio block is intermediate, additional data can be inserted into the sub-audio block according to a second pattern. Additional information insertion according to the second pattern can be performed by, for example, inserting additional data using the least significant bit of each PCM sample.

Meanwhile, when the energy level of a predetermined number of audio blocks are continuously low, additional information can be inserted using the least significant bits of the PCM sample of the current audio block.

Furthermore, according to a third pattern, additional information may be inserted in a predetermined number of sub-audio block units.

Later on, the audio data inserted with the additional information data packet can be recorded on an audio CD track.

FIG. 7 is a flow chart illustrating operations performed in the encoder illustrated in FIG. 3.

In operation 710, the length of the standard block to calculate the energy level according to characteristics of the input audio signal is determined. For example, when the input audio signal is a music signal, the length of the standard block is longer than that of a speech signal. The audio signal of the determined data unit is called an audio block.

In operation 720, the energy level of the input audio signal is determined in the audio block unit. In the present embodiment, the energy level of the audio frame is classified into low, intermediate, or high.

In operation 730, based on the energy level information determined in operation 720, an additional information data packet, which will be inserted into the audio signal, is generated. In the present embodiment, additional information data packets such as those shown in FIG. 4 or 5 are generated.

In operation 740, additional information data packets generated in operation 730 are randomised. As another option, operation 740 may be omitted.

In operation 750, taking into account the energy level determined in operation 720, the randomised additional information data packets can be inserted into sub-blocks, for example, in an audio stream in PCM sample units. For example, when the energy level of the current audio block is low, additional information insertion is skipped. However, as another option, even if the energy level of the current audio block is low, when the energy level of the previous and post audio block is intermediate or high, additional data can be inserted according to the first pattern (described supra). In addition, when the energy level of the current audio block is intermediate, additional data can be inserted into sub-audio blocks according to the second pattern (described supra). Furthermore, when the energy level of the current audio block is high, additional data can be inserted into the sub-audio block according to the third pattern (described supra). Meanwhile, when the energy level of a predetermined number of audio blocks are continuously low for a certain period of time, additional information can be inserted using the least significant bit of the PCM sample of the current audio block.

In the present embodiment, audio data with the additional information data packets is inserted into an audio signal after randomising the generated additional information data packets. However, as another option, the additional information data packets may be inserted into the audio signal without being randomised.

Later on, the audio data inserted with the additional information data packets can be recorded on the audio CD track.

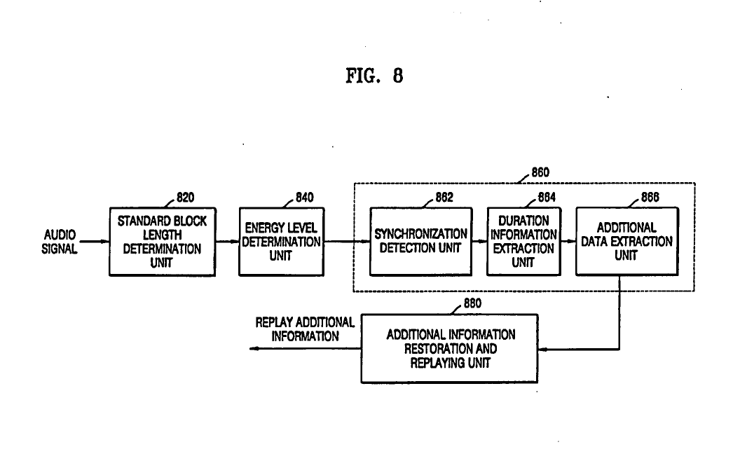

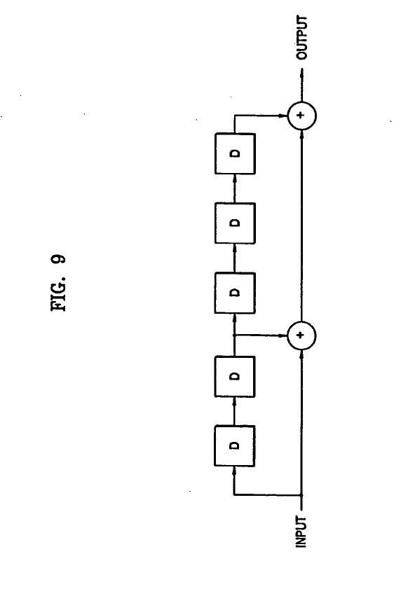

FIG. 8 is a block view of a decoder according to another embodiment of the present general inventive concept.

The decoder shown in FIG. 8 includes a standard block length determination unit 820, an energy level determination unit 840, an additional information extraction unit 860, and an additional information restoration and replaying unit 880. The additional information extraction unit 860 includes a synchronization detection unit 862, a duration information extraction unit 864, and an additional data extraction unit 866.

Similar to the standard block length determination unit 310 of the encoder shown in FIG. 3, the standard block length determination unit 820 determines the length of a standard block, that is, an audio block, taking into account the characteristics of an input audio signal. In the present embodiment, the length of the audio block is determined to calculate the energy level using the standard block length determination unit 820. However, as another option, it is possible to use an audio block having a predetermined length.

Similar to the energy level determination unit 320 of the decoder shown in FIG. 3, the energy level determination unit 840 calculates the energy level of the input audio signal in audio block units with determined lengths in the standard block length determination unit 820. The calculated energy level is output to the synchronization detection unit 862.

When the energy levels of the current audio block which are input from the energy level determination unit 840 are intermediate or high, the synchronization detection unit 862 extracts a synchronization word from the sub-audio block, for example, the least significant bit of the PCM samples, and tests whether it matches a synchronization word inserted in the encoder of FIG. 3. When the synchronization words match, the result is output to the duration information extraction unit 864.

In the present embodiment, the synchronization detection unit 862 performs a synchronization detection operation only when the energy levels of the current audio blocks are intermediate or high, or as another option, even when the energy level of the current audio block is low and the energy level of the previous or post audio block of the current audio block is intermediate or high, the synchronization detection operation may be performed.

In addition, the synchronization detection unit 862 can extract synchronization information from the PCM samples of the current audio block when the energy levels of the predetermined number of audio blocks are continuously low, and can test whether a synchronization word of the extracted synchronization information matches a synchronization word inserted in the encoder. When the synchronization words match the result is output to the duration information extraction unit 864.

The synchronization detection unit 862, as another option, can include a descrambler (not shown), and when performing randomising of additional information data packets in the encoder, synchronized information is detected after descrambling is performed on the data extracted from the least significant bit of the PCM samples.

FIG. 9 illustrates a descrambler including a feedback shift register used in the synchronization detection unit 862. The feedback shift register of FIG. 9 extracts bits from a PCM sample, maintains one delay line, and is used to test the validity of the synchronization word by descrambling the data of the delay line.

The duration information extraction unit 864 of FIG. 8 can extract duration information based on the input from the synchronization detection unit 862. For example, when the synchronization word is detected from the synchronization detection unit 862, 16 bits of duration information is extracted from the least significant bit of the PCM samples.

The additional data extraction unit 866 extracts additional data based on the energy level information of the audio blocks from the energy level determination unit 840 and the duration information from the duration information extraction unit 864.

As an option, if the energy level of the current audio block is low, and the energy level of the previous or post audio block is intermediate or high, additional data can be extracted according to a first pattern from the PCM samples. The method of extracting additional data according to the first pattern, for example, is performed by extracting additional data from the least significant bit of the PCM sample in intervals of five PCM samples.

In addition, when the energy level of the current audio block is intermediate, additional data can be extracted according to a second pattern from the PCM samples determined by the duration information. The additional information extraction method according to the second pattern, for example, extracts additional data from the least significant bit of each PCM sample.

Furthermore, when the energy level of the current audio block is high, additional data can be extracted according to a third pattern from the PCM samples determined by duration information. The method of extracting additional information according to the third pattern, for example, is performed by extracting additional data from multiple bits of each PCM sample.

Meanwhile, as another option, when the energy levels of a predetermined number of audio blocks are continuously low and the synchronization words match, additional data can be extracted from the least significant bit of the PCM samples determined by duration information.

The additional information restoration and replaying unit 880 can include a buffer (not shown) to buffer additional data extracted from the additional data extraction unit 866 and can replay buffered additional information.

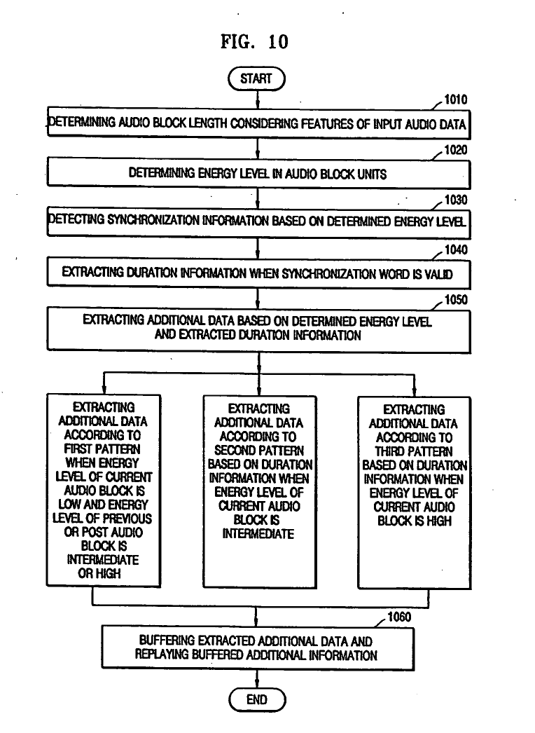

FIG. 10 is a flow chart to illustrate operations performed in the decoder shown in FIG. 8.

In operation 1010, the length of a standard block, i.e., an audio block, is adaptively determined while taking into account characteristics of the input audio signal. In the present embodiment, the length of the standard block is adaptively determined by taking into account the characteristics of the input audio signal. However, as another option, audio blocks with a predetermined length may also be used.

In operation 1020, the energy level is determined in audio block units with a predetermined length.

In operation 1030, synchronization information is extracted based on the energy level determined in operation 1020. For example, when the energy level of the current audio block is intermediate or high, the synchronization information can be extracted from the sub-audio block of the current audio block, i.e., from PCM samples. Then, a synchronization word from the extracted synchronization information and the synchronization word inserted in the encoder are tested for a match.

In operation 1040, when synchronization words match each other, duration information is extracted.

In operation 1050, additional data can be extracted based on the energy level determined in operation 1020 and the duration information extracted from operation 1040.

As another option, when the energy level of the current audio block is low and the energy levels of the previous or post audio blocks are intermediate or high, additional data can be extracted according to the first pattern from the PCM samples, which are determined by the duration information.

In addition, when the energy level of the current audio block is intermediate, additional data can be extracted according to the second pattern from the PCM samples determined by the duration information.

Furthermore, when the energy level of the current audio level is high, additional data can be extracted according to the third pattern from the PCM samples determined by the duration information.

As another option, when the energy levels of the predetermined number of audio blocks are continuously low and synchronization words match each other, additional data is extracted from the least significant bit of the PCM samples determined by the duration information.

In operation 1060, extracted additional data is buffered and the buffered additional information is replayed.

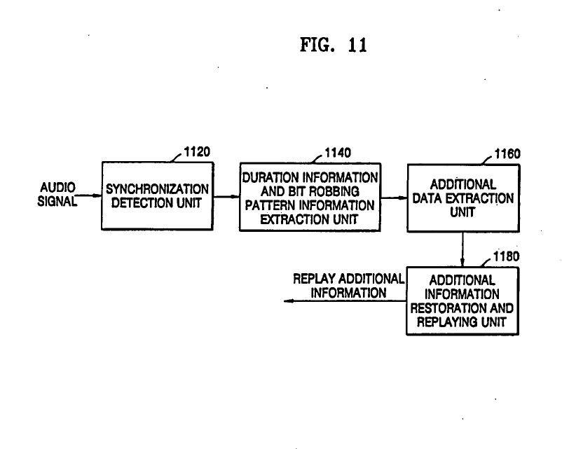

FIG. 11 is a block diagram of a decoder according to another embodiment of the present general inventive concept.

The decoder according to FIG. 11 includes a synchronization detection unit 1120, a duration information and bit-robbing pattern information extraction unit 1140, an additional data extraction unit 1160, and an additional information restoration and replaying unit 1180.

The synchronization detection unit 1120 extracts the least significant bits of all input sub-audio blocks and detects the start synchronization word. As an option, when the additional information data packet is randomised in the encoder, the synchronization detection unit 1120 uses a descrambler (not shown), to descramble the information in the extracted least significant bits, and detects the start synchronization word.

The duration information and bit-robbing pattern information extraction unit 1140 extracts duration information and bit-robbing pattern information when a start synchronization word is detected in the synchronization detection unit 1120.

The additional data extraction unit 1160 extracts additional data based on the extracted duration information and bit-robbing pattern information from the sub-audio blocks, i.e., the PCM samples.

The duration information is the information that some bits use to specify bit-robbed PCM samples to insert additional data. For example, the duration information indicates the number of PCM samples, which includes bits in which additional data is inserted, in the current audio block.

Meanwhile, the bit-robbing pattern information indicates the number of bits which are bit-robbed among the bits of the sub-audio block which are determined by taking into account the energy level of the audio signal and the psychoacoustic effect. As an option, the bit-robbing pattern information indicates the intervals of the sub-audio block in which the number of bits which are bit robbed in the sub-audio block, and the method of bit-robbing, is applied. For example, the bit-robbing pattern information may indicate additional information is inserted into four bits of least significant bits in each fifth sub-audio block.

The additional information restoration and replaying unit 1180 includes a buffer (not shown) to buffer extracted additional data and replays buffered additional information.

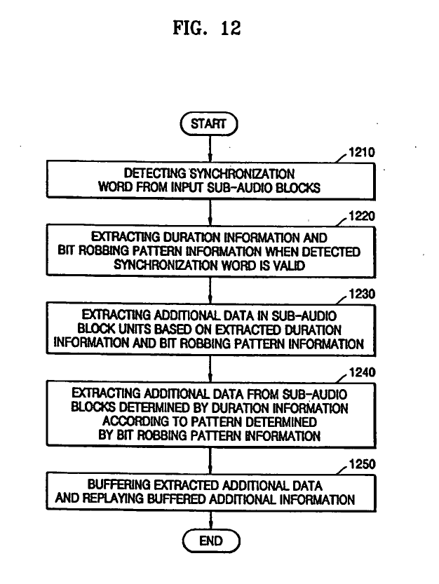

FIG. 12 is a flow chart illustrating the operation carried out in the decoder shown in FIG. 11.

In operation 1220, least significant bits of all input sub-audio blocks are extracted and the start synchronization word is detected. As an option, when additional information data packets are randomised in the encoder, start synchronization words are detected after descrambling the information of the extracted least significant bits.

In operation 1230, when the start synchronization word detected in operation 1210 is valid, duration information and bit-robbing pattern information is extracted.

In operation 1240, additional data is extracted from the sub-audio block, for example, PCM samples based on the duration information and bit-robbing pattern information extracted in operation 1220. Additional data is extracted from PCM samples determined by duration information in intervals of number of bits and/or sub-audio blocks determined by bit-robbing pattern information.

In operation 1250, additional data extracted in operation 1240 are buffered and the buffered additional information is replayed.

The present general inventive concept can be realized as a code on a recording medium readable by a computer. The recording medium, which a computer can read, includes all kinds of recording devices which store data that can be read by a computer system. ROM, RAM, CD-ROMs, magnetic tapes, hard disks, floppy disks, flash memory, and optical data storing devices are examples of the recording medium. The recording medium can also be in a carrier wave form (for example, transmission through the Internet). Furthermore, the recording medium can be accessed from a computer in a computer network, and the code can be stored and executed in a remote method.

As described above since the method of inserting additional information according to the present general inventive concept by using the psychoacoustic effect adjusts the number of bits which are bit robbed according to the energy level it is possible to insert more additional information into audio data while a listener can not perceive a deterioration in audio sound quality. The present general inventive concept can be applied to various applications using the inserted additional information.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A method of adaptively inserting additional information into audio data, the method comprising:
computing an energy value of the audio data in audio block units which have a predetermined size;
determining an insertion pattern used to insert the additional information based on the computed energy value of a current audio block; and
inserting additional the information in sub-audio block units of the current audio block based on the determined insertion pattern.

2. The method of claim 1, further comprising determining the size of the audio block according to characteristics of the audio data.

3. The method of claim 1, wherein the insertion pattern indicates a number of bits and/or position of bits in the sub-audio block used to insert the additional information.

4. The method of claim 1, wherein inserting the additional information is skipped when the energy value of the current audio block is less than a first reference value.

5. The method of claim 1, wherein, when the energy value of the current audio block is less than a first reference value and the energy value of the previous or post audio blocks of the current audio block are greater than the first reference value, the additional information is inserted using a predetermined number of bits of the sub-audio block.

6. The method of claim 1, wherein additional information is inserted using a predetermined number of bits of a sub-audio block when the energy value of the current audio block is greater than a second reference value or when the energy value of the current audio block is greater than a first reference value and less than the second reference value, and wherein the number of bits used when the energy value of the current audio block is greater than the second reference value is greater than in a case where the energy value of the current audio block is greater than the first reference value and less than the second reference value, and wherein the second reference value is greater than the first reference value.

7. The method of claim 1, wherein a sub-audio block is a PCM sample.

8. The method of claim 1, wherein the additional information is a packet including synchronization information, duration information, and additional data, and the duration information indicates the ranges of a sub-audio block in which additional information is inserted.

9. The method of claim 1, wherein the additional information is a packet including synchronization information, duration information, bit-robbing pattern information, and additional data information, and the duration information indicates a range of a sub-audio block in which additional information is inserted in the current audio block, and the bit rob pattern information indicates the number of bits used to insert additional information in the current sub-audio block.

10. The method of claim 1, wherein the additional information is a packet including synchronization information, duration information, bit robbing pattern information, and additional data information, and the duration information indicates a range of a sub-audio block in which additional information is inserted in the audio block, and the bit robbing pattern information indicates a number of bits used to insert additional information in the sub-audio block and intervals of sub-audio blocks used to insert the additional information.

11. The method of claim 1, wherein, when the energy value at a predetermined number of audio blocks is continuously less than a first reference value, additional information is inserted using a predetermined number of least significant bits of a sub-audio block.

12. The method of claim 1, wherein the additional information is inserted into an audio block after randomization.

13. An apparatus to adaptively insert additional information into input audio data, the apparatus comprising:
an energy level determination unit which computes an energy value of the input audio data in audio block units having a predetermined size, and determines an insertion pattern used to insert the additional information based on the computed energy value of a current audio block; and
an additional information insertion unit which inserts additional information in sub-audio block units of the current audio block based on the determined insertion pattern.

14. The apparatus of claim 13, further comprising a standard block length determination unit which determines a size of the current audio block according to characteristics of the input audio data.

15. The apparatus of claim 13, wherein the insertion pattern indicates the number of bits and/or the position of bits used to insert the additional information in a sub-audio block.

16. The apparatus of claim 13, wherein the additional information insertion unit inserts the additional information using a predetermined number of bits when the energy value of the current audio block is smaller than a first reference value and the energy value of the previous or post audio block of the current audio block is larger than the first reference value.

17. The apparatus of claim 13, wherein the additional information insertion unit inserts the additional information using a predetermined number of bits of a sub-audio block when an energy value of the current audio block is larger than a second reference value or an energy value of the current audio block is larger than a first reference value and smaller than the second reference value, and wherein the number of bits used when an energy value of the current audio block is larger than the second reference value is greater than when the energy level of the current audio block is larger than the first reference value and smaller than the second reference value, and wherein the second reference value is larger than the first reference value.

18. The apparatus of claim 13, wherein a sub-audio block is a PCM sample.

19. The apparatus of claim 13, wherein the additional information is a packet including synchronization information, duration information, and additional data, and wherein the duration information indicates a range of a sub-audio block in an audio block in which additional information is inserted.

20. The apparatus of claim 13, wherein the additional information is a packet including synchronization information, duration information, bit robbing pattern information, and additional data information, wherein the duration information indicates a range of a sub-audio block in an audio block in which additional information is inserted, and wherein the bit robbing patter information indicates the number of bits used to insert additional information in the sub-audio block.

21. The apparatus of claim 13, wherein the duration information is a packet including synchronization information, duration information, bit robbing pattern information, and additional data information, wherein the duration information indicates a range of a sub-audio block in the current block in which additional information is inserted, and wherein the bit robbing pattern information indicates the number of bits used to insert additional information in the sub-audio blocks and intervals of the sub-audio blocks used to insert the additional information in the sub-audio block.

22. The apparatus of claim 13, wherein, when the energy value of the predetermined number of audio blocks is continuously less than a first reference value, the additional information is inserted using a predetermined number of least significant bits of a sub-audio block.

23. The apparatus of claim 13, further comprising an additional information randomization unit which outputs randomized additional information to the additional information insertion unit.

24. A method of reproducing additional information inserted into audio data, the method comprising:
computing an energy value of the audio data in audio block units of a predetermined size;
determining an insertion pattern used to insert the additional information based on the computed energy value of a current audio block; and
extracting the additional information inserted into the current audio block in sub-audio block units based on the determined insertion pattern.

25. The method of claim 24, further comprising determining a size of an audio block according to the characteristics of the input audio data.

26. The method of claim 24, wherein the insertion pattern indicates the number of bits and/or the position of bits used to insert the additional information in a sub-audio block.

27. The method of claim 24, further comprising detecting a synchronization word from a least significant bit of the sub-audio blocks when the computed energy value of the current audio block is greater than a first reference value.

28. The method of claim 24, wherein, when the energy value of the current audio block is less than a first reference value, the operation of extracting the additional information is skipped.

29. The method of claim 24, wherein additional information is extracted from a predetermined number of bits of a sub-audio block when the energy value of the current audio block is less than a first reference value and the energy value of a previous or post audio block is less than the first reference value.

30. The method of claim 24, wherein the additional information is extracted from a predetermined number of bits of a sub-audio block when the energy value of the current audio block is less than a first reference value and the energy value of a previous or post audio block is less than a second reference value.

31. The method of claim 24, wherein a sub-audio block is a PCM sample.

32. The method of claim 24, wherein the additional information is a packet including synchronization information, duration information, and additional data, and the duration information indicates a range of a sub-audio block in which additional information is inserted in the current audio block.

33. The method of claim 32, wherein extracting the additional information is performed on a sub-audio block specified by the duration information.

34. The method of claim 24, wherein additional information is extracted from a least significant bit of a sub-audio block when a predetermined number of audio blocks are continuously less than a first reference value.

35. An apparatus to replay additional information inserted into input audio data, the apparatus comprising:
an energy level determination unit which computes an energy value of the input audio data in audio block units of a predetermined size; and
an additional information extraction unit which determines an insertion pattern used to insert the additional information based on the computed energy value, and extracts additional information inserted in sub-audio block units of a current audio block based on the determined insertion pattern.

36. The apparatus of claim 35 further comprising a standard block length determination unit which determines a size of an audio block according to characteristics of input audio data.

37. The apparatus of claim 35, wherein the insertion pattern indicates a number of bits and/or a position of bits used to insert the additional information in a sub-audio block.

38. The apparatus of claim 35, further comprising a synchronization detecting unit which detects a synchronization word from the least significant bit of the sub-audio blocks when the computed energy value of the current audio block is larger than a first reference value.

39. The apparatus of claim 35, wherein the additional information extracting unit extracts the additional information from a predetermined number of bits of a sub-audio block when the energy level of the current audio block is less than a first reference value and the energy value of a previous audio block or post audio block is greater than the first reference value.

40. The apparatus of claim 35, wherein a sub-audio block is a PCM sample.

41. The apparatus of claim 35, wherein the additional information is a packet including synchronization information, duration information, and additional data, and the duration information indicates a range of a sub-audio block in which additional information is inserted in the current audio block.

42. The apparatus of claim 35, wherein the additional information extracting unit extracts additional information from least significant bits of the sub-audio blocks when the energy values of a predetermined number of audio blocks are continuously less than a first reference value.

43. A method of reproducing additional information inserted into audio data, the method comprising:
detecting synchronization information including a start synchronization word from the audio data;
extracting duration information and bit robbing pattern information in sub-audio block units when the detected start synchronization word is valid; and
extracting additional information from sub-audio blocks based on the extracted duration information and bit robbing pattern information; and
wherein the duration information indicates a range of the sub-audio blocks in which the additional information is inserted, and the bit robbing pattern information includes information on a number of bits used to insert additional information in the sub-audio blocks.

44. The method of claim 43, wherein the start synchronization word is detected from the least significant bit of the sub-audio blocks.

45. The method of claim 43, wherein a sub-audio block is a PCM sample.

46. The method of claim 43, wherein the bit-robbing pattern information includes information on intervals of the sub-audio block in which the additional information is inserted.

47. An apparatus to reproduce additional information inserted into input audio data, the apparatus comprising:
a synchronization detecting unit which detects synchronization information including a start synchronization word from the input audio data;
a duration and bit robbing pattern information extracting unit which extracts duration information and bit robbing pattern information in sub-audio block units when the detected start synchronization word is valid; and
an additional information extracting unit extracting additional information from sub-audio blocks based on the extracted duration information and bit robbing pattern information;
wherein the duration information indicates a range of the sub-audio blocks in which the additional information is inserted and the bit robbing pattern information includes information on a number of bits used to insert information in the sub-audio blocks.

48. The apparatus of claim 47, wherein the synchronization detecting unit detects the start synchronization word from a least significant bit of the input sub-audio blocks.

49. The apparatus of claim 47, wherein a sub-audio block is a PCM sample.

50. The apparatus of claim 47, wherein the bit robbing pattern information includes information on intervals of sub-audio blocks in which the additional information is inserted.

51. A computer readable recording medium having recorded thereon a program to execute a method of adaptively inserting additional information into audio data, the method comprising:
calculating an energy value of the audio data in audio block units having a predetermined size;
determining an insertion pattern used to insert the additional information based on the calculated energy value of a current audio block; and
inserting additional information in sub-audio block units of the current audio block based on the determined insertion pattern.

52. The recording medium of claim 51, the method further comprising determining a size of the current audio block according to the input audio data.

53. The recording medium of claim 51, wherein the insertion pattern indicates a number of bits and/or a position of a bit used to insert the additional information in a sub-audio block.

54. The recording medium of claim 51, wherein the additional information is inserted when the energy value of the current audio block is less than a first reference value.

55. The recording medium of claim 51, wherein the additional information is inserted using a predetermined number of bits of a sub-audio block when the energy value of the current audio block is less than a first reference value and the energy value of a previous or post audio block of the current audio block is greater than the first reference value.

56. The recording medium of claim 51, wherein, when the energy value of the current audio block is greater than a second reference value or the energy value of the current audio block is greater than a first reference value and less than the second reference value, the additional information is inserted using a predetermined number of bits of a sub-audio block, and a number of bits used when the energy value of the current audio block is greater than the second reference value is greater than when the energy level of the current audio block is greater than the first reference value and less than the second reference value, and the second reference value is greater than the first reference value.

57. The recording medium of claim 51, wherein a sub-audio block is a PCM sample.

58. The recording medium of claim 51, wherein the additional information is a packet including synchronization information, duration information, and additional data, and wherein the duration information indicates a range of the sub-audio blocks in which additional information is inserted in the current audio block.

59. The recording medium of claim 51, wherein the additional information is a packet including synchronization information, duration information, bit-robbing pattern information, and additional data information, and the duration information indicates a range of the sub-audio blocks in which inserted information is inserted in the current audio block, and the bit robbing pattern information indicates a number of bits used to insert additional information in a sub-audio block.

60. The recording medium of claim 51, wherein the additional information is a packet including synchronization information, duration information, bit robbing pattern information, and additional data information, the duration information indicates a range of the sub-audio blocks in which additional information is inserted in the current audio block, and the bit robbing pattern information indicates a number of bits used to insert additional information in the sub-audio blocks and intervals of the sub-audio blocks which are used to insert the additional information.

61. The recording medium of claim 51, wherein additional information is inserted using a predetermined number of least significant bits of the sub-audio blocks when the energy levels of a predetermined number of blocks are continuously lower than a first reference value.

62. A computer readable recording medium having recorded thereon a program to execute a method of adaptively inserting additional information into audio data, the method comprising:
calculating an energy value of the audio data in audio block units having a predetermined size;
determining an insertion pattern used to insert the additional information based on the calculated energy value of a current audio block; and
extracting additional information which is inserted in sub-audio block units of the current audio block based on the determined insertion pattern.

63. The recording medium of claim 62, the method further comprising determining a size of the current audio block according to characteristics of the input audio data.

64. The recording medium of claim 62, wherein the insertion pattern indicates a number of bits and/or a position of bits used to insert the additional information in a sub-audio block.

65. The recording medium of claim 62 further comprising detecting a synchronization word from a least significant bit of the sub-audio blocks when the computed energy value of the current audio block is less than a first reference value.

66. The recording medium of claim 62, wherein the extracting of the additional information is skipped when the energy value of the current audio block is less than a first reference value.

67. The recording medium of claim 62, wherein the additional information is extracted from a predetermined number of bits of a sub-audio block when the energy value of the current audio block is less than a first reference value and the energy value of a previous or post audio block is greater than the first reference value.

68. The recording medium of claim 62, wherein the additional information is extracted from a predetermined number of bits of a sub-audio block when the energy value of the current audio block is less than a first reference value and the energy value of a previous or a post audio block is greater than a second reference value.

69. The recording medium of claim 62, wherein a sub-audio block is a PCM sample.

70. The recording medium of claim 62, wherein the additional information includes synchronization information, duration information, and additional data, and the duration information indicates a range of the sub-audio blocks in which additional information is inserted in the current audio block.

71. The recording medium of claim 70, wherein extracting the additional information is performed on an audio block designated by the duration information.

72. The recording medium of claim 62, wherein additional information is extracted from a least significant bit of the sub-audio blocks when the energy values of the predetermined number of audio blocks are continuously less than a first reference value.

73. A computer readable recording medium having recorded thereon a program executing a method of adaptively inserting additional information into audio data, the method comprising:
detecting synchronization information from the audio data;
extracting duration information and bit robbing pattern information in sub-audio block units of a current audio block when the detected synchronization information is valid; and
extracting additional information from a sub-audio block based on the extracted duration information and bit robbing pattern information;
wherein the duration information indicates a range of the sub-audio blocks in which the additional information is inserted and the bit robbing pattern information includes information on a number of bits used to insert additional information into the sub-audio block.

74. The recording medium of claim 73, wherein the operation of detecting synchronization information detects a start synchronization word from a least significant bit of the sub-audio blocks.

75. The recording medium of claim 73, wherein the sub-audio block is a PCM sample.

76. The recording medium of claim 73, wherein the bit-robbing pattern information includes information on intervals of sub audio blocks in which the additional information is inserted.
